(19) United States
(12) Patent Application Publication
(10) Pub. No.: US 2012/0193821 A1
(43) Pub. Date: Aug. 2, 2012

(54) METHOD OF MANUFACTURING LENS

(75) Inventors: Ai Takumi, Daito-shi (JP); Satoru Ohta, Osaka-shi (JP); Yasumitsu Kaseda, Kyoto-shi (JP)

(73) Assignee: SANYO ELECTRIC CO., LTD., Osaka (JP)

(21) Appl. No.: 13/294,260

(22) Filed: Nov. 11, 2011

(30) Foreign Application Priority Data
Jan. 27, 2011 (JP) 2011-015053

(51) Int. Cl. B29D 11/00

(52) U.S. Cl. 264/2.4

(57) ABSTRACT

A manufacturing method uses a molding unit to manufacture lenses out of a structure with a plurality of lens intermediates coupled to each other through a runner. The molding unit includes a holding member provided with first opening parts and second opening parts coaxial with each other, and molding chambers. First molding dies and second molding dies are inserted into the first opening parts and the second opening parts respectively. The holding member is further provided with a path that allows introduction of the lens intermediates into the molding chambers. In a manufacturing process, the lens intermediates are guided to predetermined positions in the corresponding molding chambers by operating the structure to cause the lens intermediates and the runner to move along the path. Next, a pressing pressure is applied to the lens intermediates to form molded lenses.

### INCORPORATION BY REFERENCE

Japanese patent application Number 2011-015053, upon which this patent application is based, is hereby incorporated by reference.

### BACKGROUND OF THE INVENTION

1. Field of the Invention

The invention relates to a method of manufacturing a lens, and more specifically, to a molding technique employed to form a resin lens.

2. Description of Related Art

FIG. 18 is a sectional view of a conventional molding unit used to form a glass lens. The molding unit shown in FIG. 18 includes first and second dies 81 and 82. The first and second dies 81 and 82 are held by two holding members 84 and 85 respectively while die surfaces 810 and 820 of the first and second dies 81 and 82 face each other. The first die 81 is fixed to the holding member 84, and the second die 82 is held by the holding member 85 such that the second die 82 is capable of moving back and forth in a pressing direction 83 (in the downward direction of FIG. 18). So, the first and second dies 81 and 82 are capable of moving to get closer to and farther from each other in the pressing direction 83. The die surfaces 810 and 820 have optical function transferring surfaces 811 and 821 to form optical functional surfaces of a lens.

FIGS. 19A and 19B are sectional views used to explain a method of manufacturing a lens by using the aforementioned molding unit. First, a glass sphere 86 to become a lens is placed on the optical function transferring surface 811 of the first die 81 as shown in FIG. 19A. Then, the glass sphere 86 is heated to a temperature higher than the deformation point of glass forming the glass sphere 86. Next, the second die 82 is caused to move downward to get closer to the first die 81, thereby applying a pressing pressure to the glass sphere 86 as shown in FIG. 19B. As a result, optical functional surfaces are transferred to the surface of the glass sphere 86 to form a glass lens.

As described above, the aforementioned method of manufacturing a lens heats the glass sphere 86 to a temperature higher than the deformation point of the glass. The deformation point of the glass is higher than those of different materials such as resin. So, heating of the glass sphere 86 during the manufacturing process of a lens also heats the first and second dies 81 and 82 to a high temperature. This makes the first and second dies 81 and 82 be susceptible to heat, leading to the fear of deformation or damage of the first and second dies 81 and 82.

In response, a technique of forming a lens by using resin of a lower deformation point has been suggested. To be specific, a lens intermediate to become a resin lens is formed by injection molding, and thereafter, the lens intermediate is pressed by using a molding unit to form a resin lens. The molding unit used here may be the conventional molding unit shown in FIG. 18.

The two holding members 84 and 85 of the conventional molding unit (FIG. 18) are formed as individual parts. This makes it difficult to control the positions or tilts of the first and second dies 81 and 82, so a high-precision lens is hard to form.

A molding unit may include two holding members 84 and 85 that are formed integrally with each other. In order to form this molding unit, a through hole is provided in an integral member functioning as a holding member, and the first and second dies 81 and 82 are inserted in the through hole. So, the respective central axes of the first and second dies 81 and 82 of this molding unit are unlikely to go out of alignment with each other and unlikely to tilt, making it possible to form a high-precision lens.

Meanwhile, this molding unit is capable of forming only one lens in one press molding. Further, this molding unit requires removal of the first or second dies 81 or 82 from the holding member after press molding in order to take a lens formed by the press molding out of the molding unit, and to introduce a lens intermediate as a next target of molding into the molding unit. This makes it hard to shorten an execution cycle of press molding, leading to a difficulty in reducing manufacturing costs.

### SUMMARY OF THE INVENTION

A method of manufacturing lenses of the invention uses a molding unit to manufacture lenses out of a structure with a plurality of lens intermediates coupled to each other through a runner. The molding unit includes a plurality of first molding dies, a plurality of second molding dies, and a holding member for holding the first and second molding dies. The holding member is provided with first opening parts, second opening parts, and molding chambers placed at a plurality of places. The first opening parts and the corresponding second opening parts are aligned along predetermined axes and coaxial with each other about the predetermined axes. The molding chambers exist between the first opening parts and the corresponding second opening parts. The first opening parts each receive the corresponding first molding die inserted into the first opening part, and the second opening parts each receive the corresponding second molding die inserted into the second opening part. The first molding dies and the corresponding second molding dies are capable of moving to get closer to and farther from each other along the corresponding predetermined axes. The holding member is further provided with a path through which the lens intermediates and the runner pass to allow introduction of the lens intermediates into the corresponding molding chambers from outside the holding member.

The manufacturing method includes a preparatory step, an introducing step, a heating step, a press-molding step, a demolding step, and a cutting step. The preparatory step prepares the structure. The introducing step guides the lens intermediates to predetermined positions in the corresponding molding chambers by operating the structure to cause the lens intermediates and the runner of the structure to move along the path. The heating step heats the lens intermediates. The press-molding step is performed after the introducing step and simultaneously with the heating step. The press-molding step molds the lens intermediates to form molded lenses by causing the first molding dies and the corresponding second molding dies to move to get closer to each other along the predetermined axes to apply a pressing pressure to the lens intermediates. The demolding step is performed after the press-molding step. The demolding step removes the molded lenses from the first molding dies and the corresponding second molding dies by causing the first molding dies and the corresponding second molding dies to move to get farther from each other along the predetermined axes. The cutting step is performed after the demolding step. The cutting step separates the molded lenses from the runner by cutting the structure.

In a different manufacturing method of the invention, the molding unit includes a plurality of first molding dies, a plurality of second molding dies, and a holding member for holding the first and second molding dies. The holding member is provided with first opening parts, second opening parts, and molding chambers placed at a plurality of places. The first opening parts and the corresponding second opening parts are aligned along predetermined axes and coaxial with each other about the predetermined axes. The molding chambers exist between the first opening parts and the corresponding second opening parts. The holding member is constructed of a plurality of joined components capable of being separated from each other. A path through which the lens intermediates and the runner pass is exposed at least one of joint surfaces of the components. The path allows the introduction of the lens intermediates into the corresponding molding chambers. The first opening parts each receive the corresponding first molding die inserted into the first opening part, and the second opening parts each receive the corresponding second molding die inserted into the second opening, part. The first molding dies and the corresponding second molding dies are capable of moving to get closer to and farther from each other along the corresponding predetermined axes.

In the different manufacturing method, the introducing step guides the lens intermediates to predetermined positions in the corresponding molding chambers through the path, and combines the separated components of the holding member. The heating step heats the lens intermediates. The press-molding step molds the lens intermediates to form molded lenses by causing the first molding dies and the corresponding second molding dies to move to get closer to each other along the predetermined axes to apply a pressing pressure to the lens intermediates. The demolding step removes the molded lenses from the first molding dies and the corresponding second molding dies by causing the first molding dies and the corresponding second molding dies to move to get farther from each other along the predetermined axes. The cutting step separates the molded lenses from the runner by cutting the structure.

### BRIEF DESCRIPTION OF THE DRAWINGS

FIG. 1 is a perspective view of a structure prepared in a preparatory step that is part of a method of manufacturing a lens according to an embodiment of the invention;

FIG. 2 is a perspective view of a molding unit used in the manufacturing method;

FIG. 3 is a top view of the molding unit:

FIG. 4 is a sectional view taken along line IV-IV of FIG. 3;

FIG. 5 shows a region V of FIG. 4 in an enlarged manner;

FIG. 6 is a sectional view taken along line VI-VI of FIG. 3;

FIG. 7 is a sectional view taken along line VII-VII of FIG. 4;

FIG. 8 is a perspective view used to explain a first process of an introducing step that is part of the manufacturing method;

FIG. 9 is a top view used to explain the first process;

FIG. 10 is a sectional view taken along line X-X of FIG. 9;

FIG. 11 is a top view used to explain a second process of the introducing step that is part of the manufacturing method;

FIG. 12 is a sectional view taken along line XII-XII of FIG. 11;

FIG. 13 shows a region XIII of FIG. 12 in an enlarged manner;

FIG. 14 is an enlarged sectional view used to explain a press-molding step that is part of the manufacturing method;

FIG. 15 is an enlarged sectional view used to explain a demolding step that is part of the manufacturing method;

FIG. 16 is a top view of a molding unit used in a modification of the manufacturing method;

FIG. 17 is a top view used to explain an introducing step that is part of a manufacturing method of the modification;

FIG. 18 is a sectional view of a conventional molding unit used to form a glass lens; and

FIGS. 19A and 19B are sectional views used to explain a method of manufacturing a lens by using the conventional molding unit.

### DETAILED DESCRIPTION OF THE EMBODIMENTS

The invention relates to a method of manufacturing lenses by using a molding unit. In an embodiment of the invention described in detail below by referring to the drawings, the invention is implemented to form resin lenses with two convex surfaces as optical functional surfaces.

A manufacturing method of the embodiment includes a preparatory step, an introducing step, a heating step, a press-molding step, a demolding step, and a cutting step.

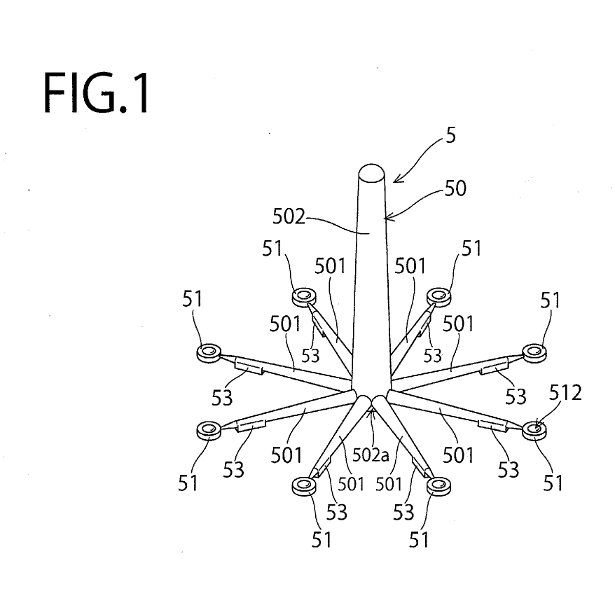

FIG. 1 is a perspective view of a structure 5 prepared in the preparatory step. As shown in FIG. 1, the structure 5 includes a runner 50, and eight lens intermediates 51 coupled to each other through the runner 50. The structure 5 is formed by injection molding and by using resin such as a polycarbonate resin. The runner 50 is constructed of eight first runner parts 501, and a second runner part 502 with which the structure 5 is operated.

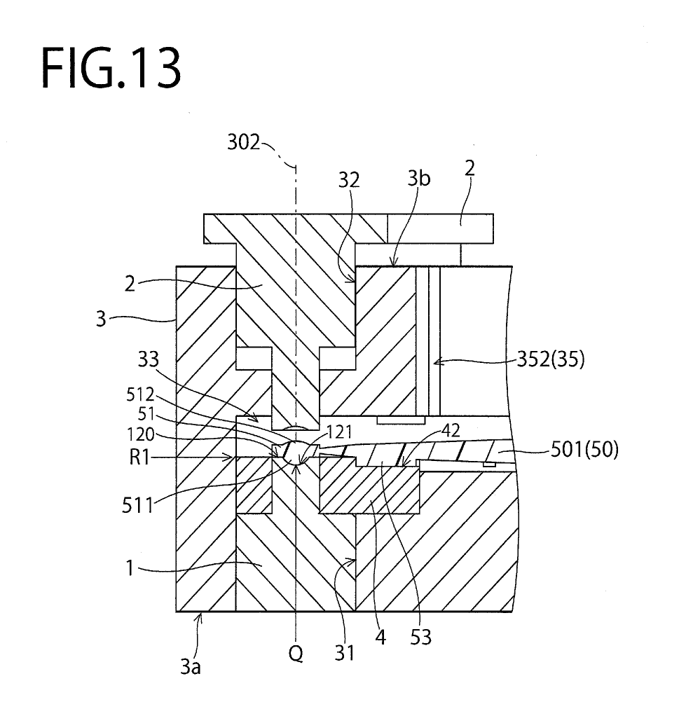

The lens intermediates 51 are formed into resin lenses by execution of the manufacturing method of the embodiment. The lens intermediates 51 each have lower and upper surfaces with protuberances 511 and 512 (see FIGS. 1 and 13) respectively having surfaces to become optical functional surfaces (convex surfaces) of a resin lens. The first runner parts 501 extend in a radial pattern from eight places of a lower end portion 502a of the second runner part 502, and are equally spaced at an angle of 45 degrees from each other around the second runner part 502. The lens intermediates 51 are each provided at the tip end of the corresponding first runner part 501, so the eight lens intermediates 51 are coupled through the first runner parts 501 to the second runner part 502. Further, as shown in FIG. 1, the first runner parts 501 are each provided with a downward pointing engaging part 53 at a position near the tip end of the corresponding first runner part 501.

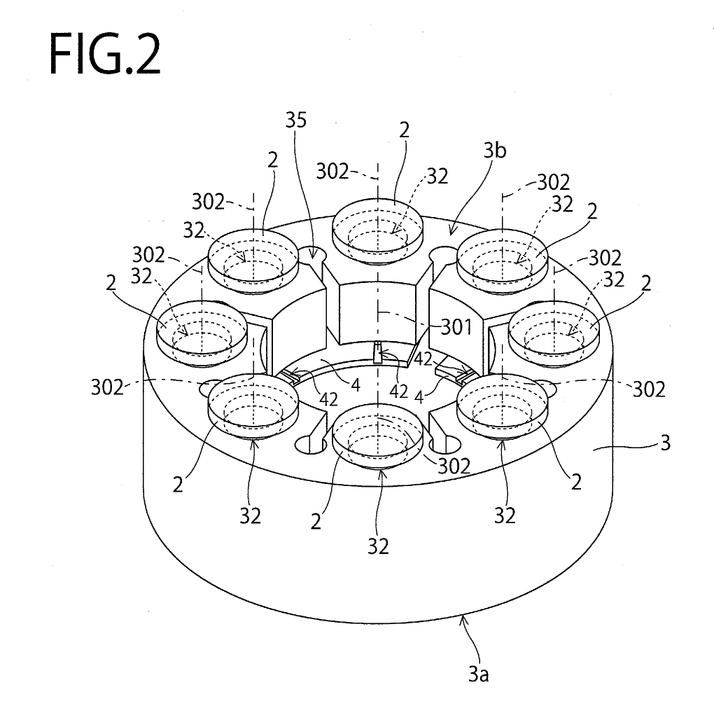

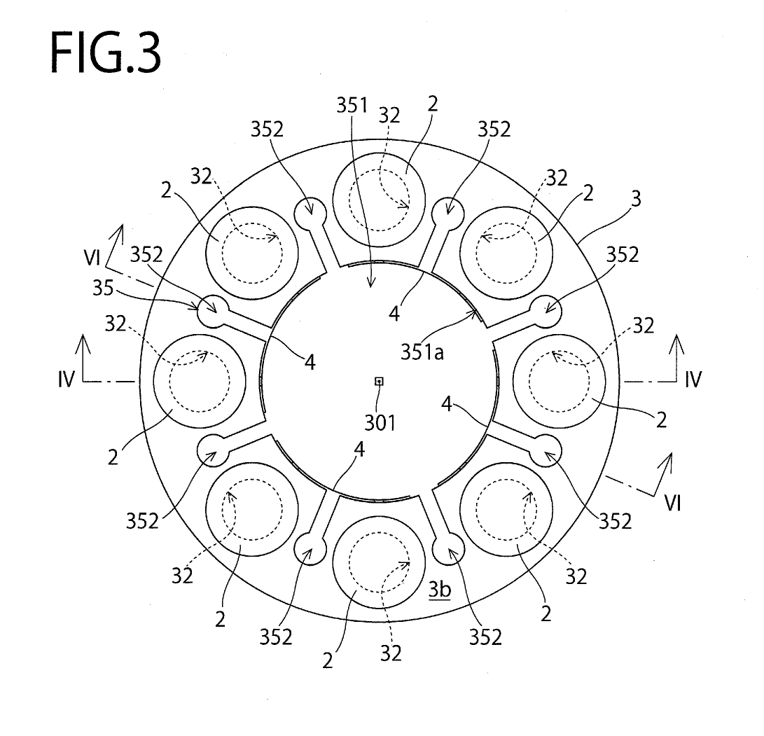

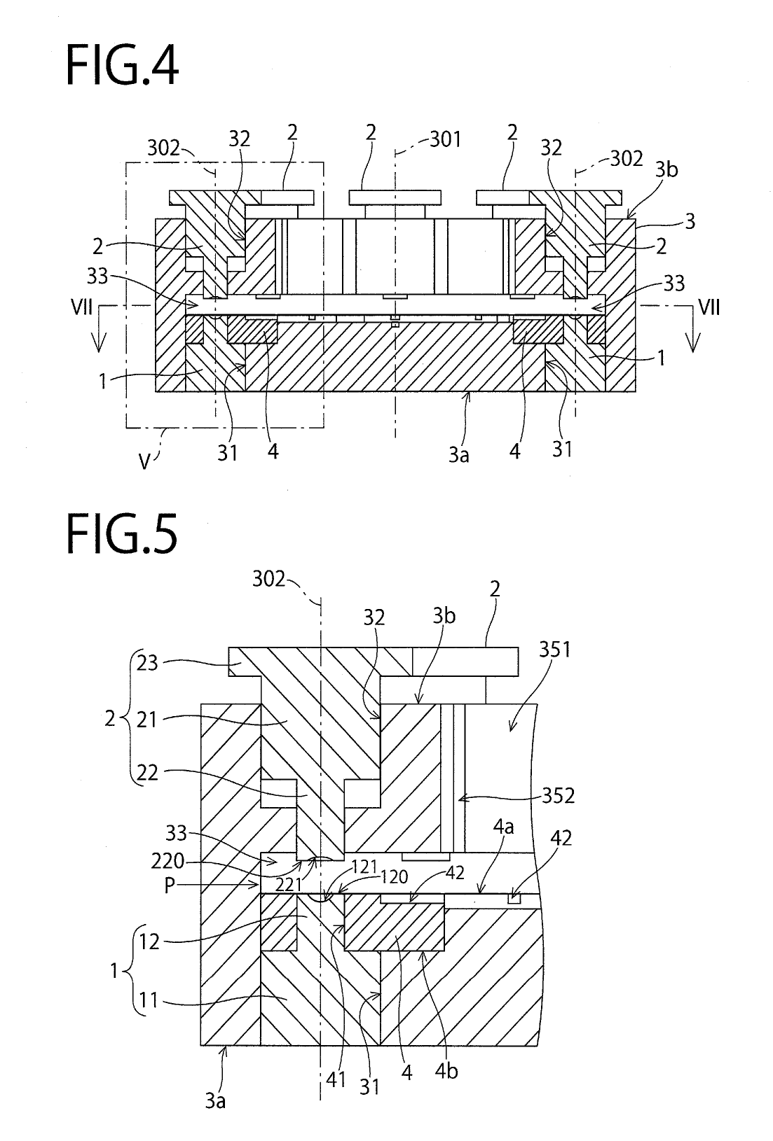

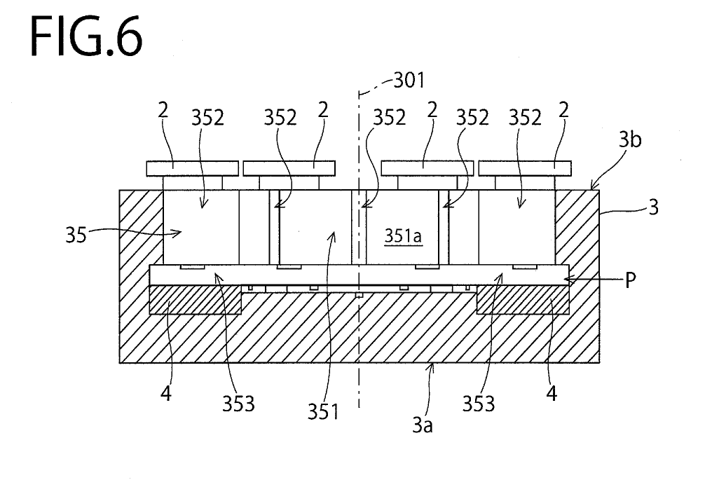

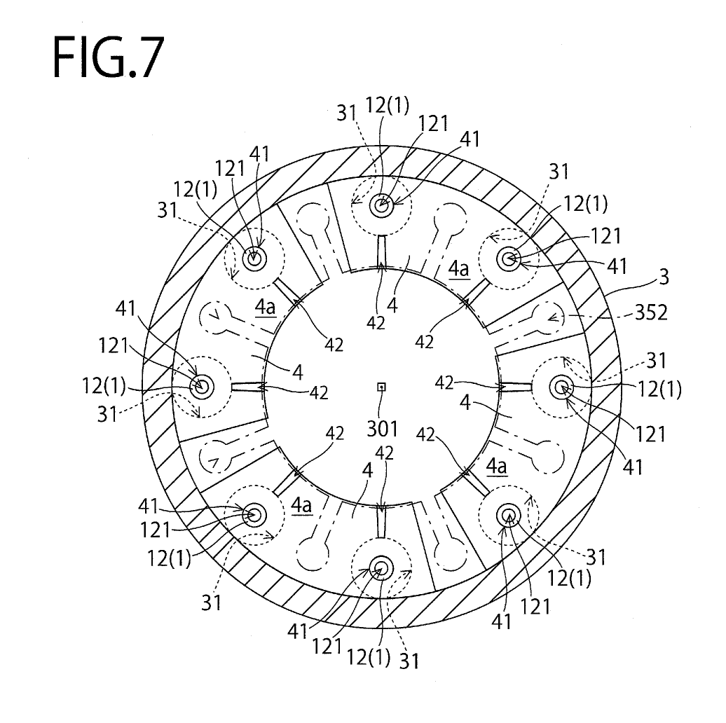

A molding unit used in the manufacturing method of the embodiment is described next by referring to FIGS. 2 to 7 before the description of the subsequent introducing step. FIGS. 2 and 3 are perspective and top views respectively of the molding unit. FIG. 4 is a sectional view taken along line IV-IV of FIG. 3. FIG. 5 shows a region V of FIG. 4 in an enlarged manner. FIG. 6 is a sectional view taken along line VI-VI of FIG. 3. FIG. 7 is a sectional view taken along line VII-VII of FIG. 4.

As shown in FIGS. 2 to 7, the molding unit includes eight first molding dies 1 (see FIGS. 4 and 7), eight second molding dies 2, and a holding member 3 for holding the first and second molding dies 1 and 2. The holding part 3 is provided with first opening parts 31 (see FIGS. 4 and 7), second opening parts 32, and molding chambers 33 (see FIG. 4) that are formed at eight places of the holding member 3 around a central axis 301 of the holding member 3. The second opening parts 32 are each placed above the first opening part 31 in relation to this first opening part 31, and the molding chambers 33 are each formed between the corresponding first and second opening parts 31 and 32 as shown in FIGS. 4 and 5.

As shown in FIG. 2, predetermined axes 302 substantially parallel to the central axis 301 are defined at eight places of the holding member 3 around the central axis 301. More specifically, the axes 302 are spaced by the same distance from the central axis 301, and are equally spaced from each other around the central axis 301. Further, as shown in FIGS. 4 and 5, each of the first opening parts 31 and the corresponding second opening part 32 are aligned along the corresponding axis 302, and are coaxial with each other about this axis 302. This means that the axes 302 each form a basis for the arrangement of each of the first opening parts 31 and the corresponding second opening part 32. Each of the first opening parts 31 and the corresponding second opening part 32 are formed by coaxial processing of the holding member 3.

The eight first opening parts 31 are exposed at a lower end surface 3a of the holding member 3 as shown in FIG. 5. A space inside each of the first opening parts 31 communicates with the molding chamber 33 corresponding to this first opening part 31. The first opening parts 31 are each circular in cross section perpendicular to the corresponding axis 302 (see FIG. 7).

The eight second opening parts 32 are exposed at an upper end surface 3b of the holding member 3 as shown in FIG. 5. A space inside each of the second opening parts 32 communicates with the corresponding molding chamber 33 corresponding to this second opening part 32. The second opening parts 32 are each circular in cross section perpendicular to the corresponding axis 302 (see FIG. 3). The second opening parts 32 each have a stepped inner surface, so the second opening part 32 has an inner diameter smaller at a lower end portion than at an upper part of the second opening part 32.

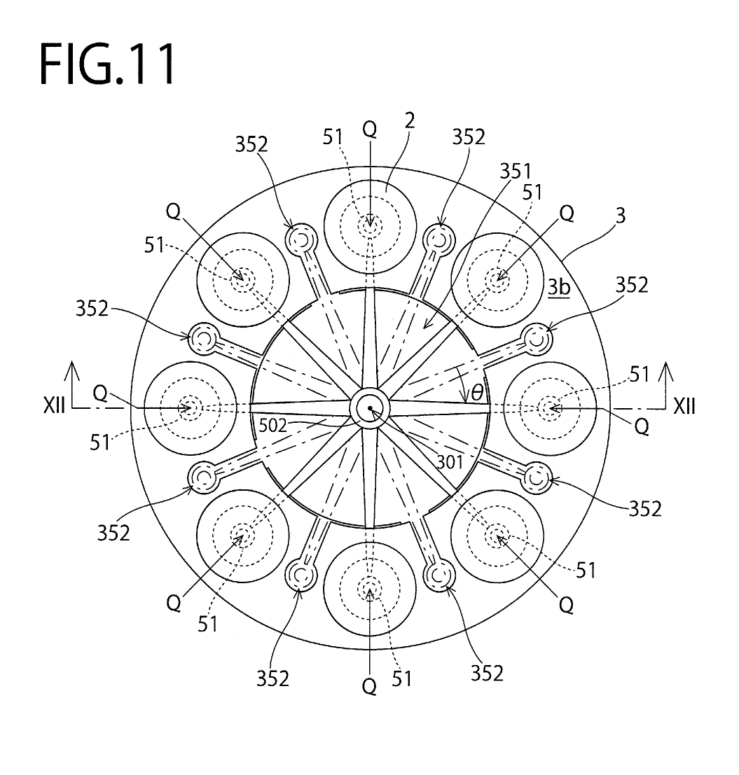

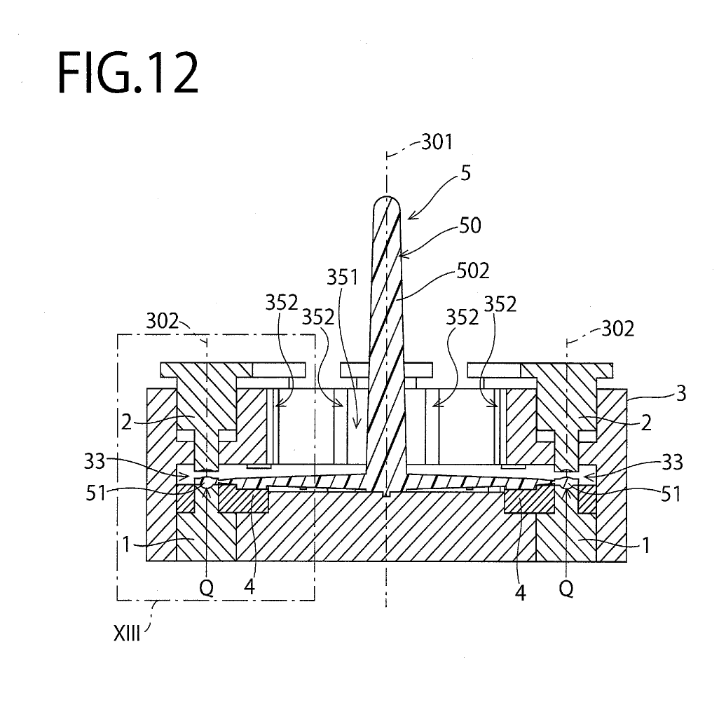

As shown in FIGS. 5 and 7, the molding chambers 33 are each provided with a movable body 4 capable of moving along the axis 302 corresponding to this molding chamber 33. The movable bodies 4 are each given through holes 41 passing through the corresponding movable body 4 along the axis 302 from an upper surface 4a to a lower surface 4b of the movable body 4. The upper surface 4a of each of the movable bodies 4 is given engagement receiving parts 42 in the form of recesses to be in engagement with the engaging parts 53 of the structure 5. The arrangement of the engagement receiving parts 42 is such that the engagement of the engaging parts 53 with the engagement receiving parts 42 places the lens intermediates 51 substantially at predetermined positions Q (see FIGS. 11 and 12) in the molding chambers 33. The positions Q are each a position where the corresponding lens intermediate 51 is subjected to press molding in the press-molding step described later. More specifically, as shown in FIG. 13, the position Q is a position where the lens intermediate 51 is placed on a die surface 120 of the first molding die 1.

As shown in FIG. 5, the first molding dies 1 each have a first column 11 slightly smaller in cross sectional area than the first opening part 31, and a second column 12 projecting from the upper end surface of the first column 11. The central axis of the second column 12 is aligned with the central axis of the first column 11. The radius of the second column 12 is smaller than that of the first column 11. The die surface 120 is formed at the upper end surface of the second column 12, and which is given an optical function transferring surface 121 to form an optical functional surface (convex surface) of a lens.

The second molding dies 2 each have a first column 21 slightly smaller in cross sectional area than the second opening part 32, a second column 22 projecting from the lower end surface of the first column 21, and a flange 23 projecting sideways from the upper end portion of the first column 21. The central axis of the second column 22 is aligned with the central axis of the first column 21. The radius of the second column 22 is smaller than that of the first column 21. A die surface 220 is formed at the lower end surface of the second column 22, and which is given an optical function transferring surface 221 to form an optical functional surface (convex surface) of a lens.

Metal dies are used as the first and second molding dies 1 and 2 of the embodiment. Meanwhile, molding dies made of materials except metal may also be used as the first and second molding dies 1 and 2.

As shown in FIG. 5, the first molding dies 1 are each inserted into the corresponding first opening part 31 while the second column 12 of the first molding die 1 faces upward. Further, the second molding dies 2 are each inserted into the corresponding second opening part 32 while the second column 22 of the second molding die 2 faces downward. As a result, the second molding dies 2 are each arranged above the corresponding first molding die 1.

The first column 11 of the first molding die 1 is fitted in the corresponding first opening part 31, thereby fixing the first molding die 1 in the first opening part 31. Further, the second column 12 of the first molding die 1 is inserted in the corresponding through hole 41 of the movable body 4 in a manner that allows the second column 12 to move slidably along the inner surface of the through hole 41 and relative to the inner surface. This allows the movable body 4 to move back and forth along the axis 302 in the corresponding molding chamber 33.

The second molding die 2 is inserted in the corresponding second opening part 32 in a manner that allows the second molding die 2 to move slidably along the inner surface of the second opening part 32. More specifically, the first column 21 of the second molding die 2 is inserted in the upper part of the second opening part 32 having a larger inner diameter in a manner that allows the sliding movement of the first column 21. Further, the second column 22 of the second molding die 2 is inserted in the lower end portion of the second opening part 32 having a smaller inner diameter in a manner that allows the sliding movement of the second column 22. Thus, the second molding die 2 is capable of moving back and forth along the corresponding axis 302 to make it possible for the first molding die 1 and the corresponding second molding die 2 to move to get closer to and farther from each other along the corresponding axis 302.

The holding member 3 is further provided with a path 35 as shown in FIG. 2 through which the lens intermediates 51 can be introduced from outside to the corresponding molding chambers 33 (see FIG. 5). The path 35 allows the lens intermediates 51 and the runner 50 to pass therethrough while the lens intermediates 51 are coupled to the first runner parts 501 of the runner 50.

More specifically, as shown in FIGS. 3 and 6, the path 35 is constructed of a first path section 351, eight second path sections 352, and a third path section 353. The first path section 351 extends along the central axis 301 from the upper end surface 3b to a depth position P substantially the same as the position of the molding chambers 33 (see FIG. 5). The second path sections 352 are formed at eight places of the holding member 3 around the central axis 301. Each of the second path sections 352 is formed between two of the second opening parts 32 adjacent to each other around the central axis 301, and which extends from the upper end surface 3b to the depth position P. The second path sections 352 are exposed at an inner surface 351a of the first path section 351 entirely over the inner surface 351a in a direction in which the first path section 351 extends, thereby forming communication of the second path sections 352 with the first path section 351.

The third path section 353 extends in a circle around the central axis 301 at the depth position P such that the third path section 353 passes through the eight molding chambers 33 (see FIG. 5). So, the third path section 353 forms communications of the second path sections 352 with the corresponding molding chambers 33 around the central axis 301. The third path section 353 is exposed at the inner surface 351a of the first path section 351 over the entire circumference of the inner surface 351a around the central axis 301, thereby forming communication of the third path section 353 with the first path section 351.

The introducing step is described next. The introducing step includes first and second processes that are performed in this order.

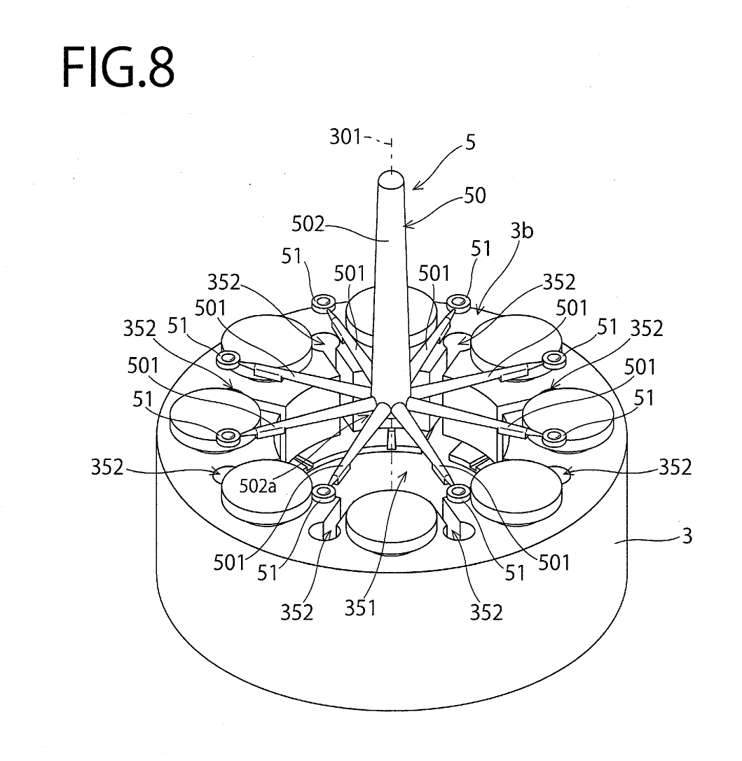

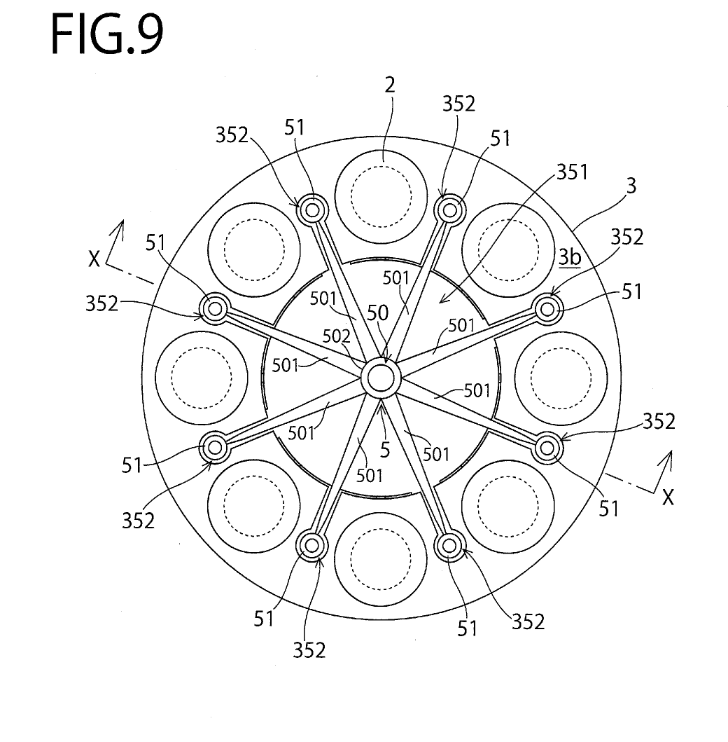

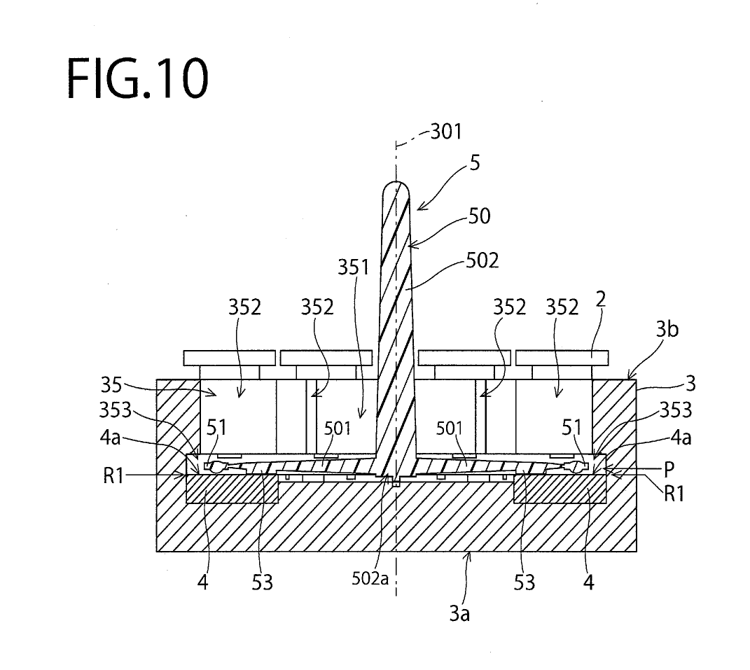

FIGS. 8 and 9 are perspective and top views respectively used to explain the first process of the introducing step. FIG. 10 is a sectional view taken along line X-X of FIG. 9. In the introducing step, the second runner part 502 of the structure 5 is operated to cause the lens intermediates 51 and the runner 50 to move along the path 35, thereby guiding the lens intermediates 51 to the positions Q (see FIGS. 10 and 12) in the corresponding molding chambers 33. In the introducing step, the upper surfaces 4a of the movable bodies 4 are placed at first positions R1 (see FIG. 10) that allow the lens intermediates 51 to be introduced into the positions Q.

In the first process of the introducing step, the second runner part 502 is operated first to place the structure 5 above the upper end surface 3b of the holding member 3 as shown in FIG. 8. At this time, the lower end portion 502a of the second runner part 502 is made to face the upper end surface 3b, and the second runner part 502 is placed along the central axis 301. Further, the eight lens intermediates 51 are made to face the corresponding second path sections 352.

Next, the second runner part 502 is caused to move downward along the central axis 301, thereby inserting the second runner part 502 into the first path section 351, and inserting the eight lens intermediates 51 and the eight first runner parts 501 into the corresponding second path sections 352. Then, the second runner part 502 is caused to move downward further along the central axis 301 until the lower end portion 502a reaches the depth position P as shown in FIG. 10. As a result, the lens intermediates 51 reach the third path section 353. At this time, the engaging parts 53 of the structure 5 are in abutting contact with the upper surfaces 4a of the movable bodies 4, so the lens intermediates 51 are slightly spaced upward from the upper surfaces 4a.

FIG. 11 is a top view used to explain the second process of the introducing step. FIG. 12 is a sectional view taken along line XII-XII of FIG. 11. FIG. 13 shows a region XIII of FIG. 12 in an enlarged manner. As shown in FIG. 11, in the second process of the introducing step, the second runner part 502 is caused to rotate a predetermined angle θ about the central axis 301 to move the eight lens intermediates 51 to the corresponding positions Q (see FIG. 12) through the third path section 353 (see FIG. 10).

The lens intermediates 51 are slightly spaced upward from the upper surfaces 4a as described above. This prevents the lens intermediates 51 from touching the upper surfaces 4a while the second runner part 502 rotates, so the lens intermediates 51 will not be damaged. As shown in FIG. 13, the rotation of the second runner part 502 forms engagement of each of the engaging parts 53 with the corresponding engagement receiving part 42, thereby placing each of the lens intermediates 51 on the corresponding first molding die 1. As a result, the eight lens intermediates 51 are guided to the corresponding positions Q.

In the heating step performed after the introducing step, the temperatures of the first and/or second molding dies 1 and/or 2 are increased to heat the eight lens intermediates 51 through the first and/or second molding dies 1 and/or 2. Thus, the temperatures of the lens intermediates 51 are increased to a predetermined temperature at which the lens intermediates 51 are easily deformed by external force. The predetermined temperature is a temperature higher than the deformation point of resin forming the lens intermediates 51. As a result, residual stresses in the lens intermediates 51 are relaxed to remove much of optical distortion in the lens intermediates 51.

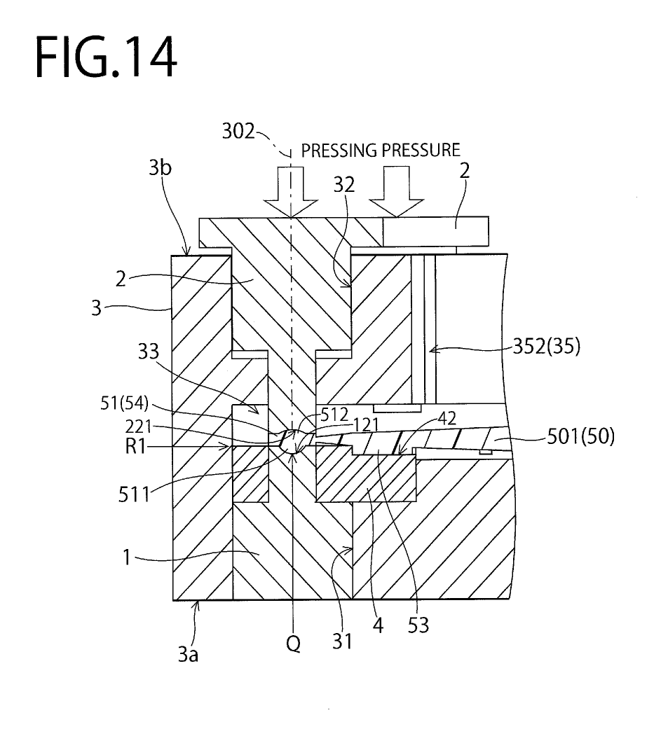

FIG. 14 is an enlarged sectional view used to explain the press-molding step. In the press-molding step, the eight second molding dies 2 are caused to move downward along the corresponding axes 302 as shown in FIG. 14. So, each of the second molding dies 2 and the corresponding first molding die 1 are caused to get closer to each other along the axis 302 to apply a pressing pressure to the corresponding lens intermediate 51, thereby molding the lens intermediate 51 to form a molded lens 54. The press-molding step is performed concurrently with the heating step.

Execution of the press-molding step transfers the shape of the optical function transferring surfaces 121 of the first molding dies 1 onto surfaces of the protuberances 511 at the respective lower surfaces of the lens intermediates 51, and transfers the shape of the optical function transferring surfaces 221 of the second molding dies 2 onto surfaces of the protuberances 512 at the respective upper surfaces of the lens intermediates 51. As a result, the upper and lower surfaces of each of the lens intermediates 51 become optical functional surfaces (convex surfaces) to form the lens intermediate 51 into the molded lenses 54.

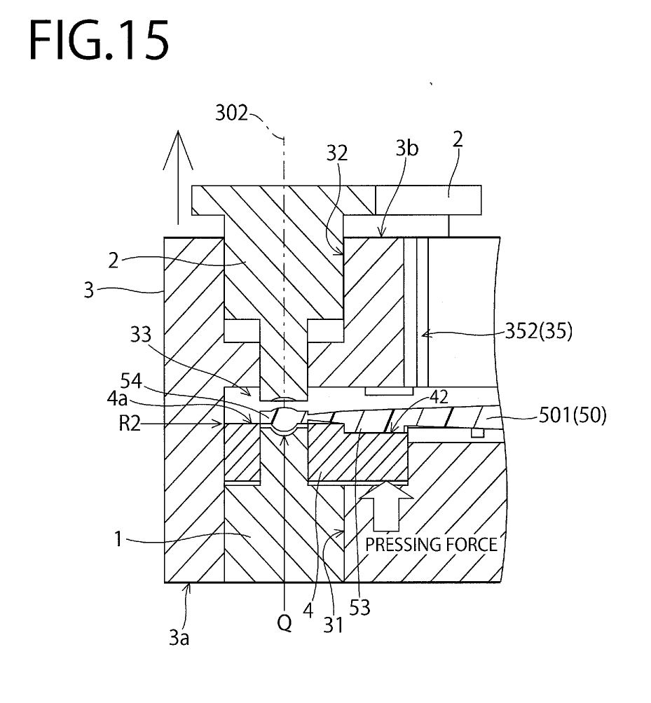

FIG. 15 is an enlarged sectional view used to explain the demolding step. The demolding step is performed after the press-molding step. First, in the demolding step, the eight second molding dies 2 are each caused to move upward along the corresponding axis 302 to make the second molding die 2 and the corresponding first molding die 1 get farther from each other as shown in FIG. 15. As a result, the molded lenses 54 are each removed from the corresponding second molding die 2.

Next, an upward pressing force is applied from below to each of the movable bodies 4, thereby moving the upper surface 4a of the movable body 4 to a second position R2 that shifts the molded lens 54 slightly upward along the axis 302 from the position Q in the corresponding molding chamber 33. So, the molded lenses 54 are each slightly shifted upward along the axis 302 from the position Q, thereby removing the molded lens 54 from the first molding die 1.

The eight molded lenses 54 are thereafter taken out of the holding member 3. This is realized by following the reverse procedure to the introducing step, so the eight molded lenses 54 are taken out while the molded lenses 54 are coupled to the first runner parts 501.

In the cutting step performed after the demolding step, the structure 5 is cut to separate the molded lenses 54 from the first runner parts 501, thereby forming resin lenses from the molded lenses 54.

In the molding unit used in the aforementioned manufacturing method, the first opening parts 31 and the corresponding second opening parts 32 are coaxial with each other. Thus, the respective central axes of the first and second molding dies 1 and 2 inserted into the first opening parts 31 and the corresponding second opening parts 32 respectively are unlikely to go out of alignment with each other, and unlikely to tilt from the corresponding axes 302. In particular, formation of optical functional surfaces on opposite surfaces of each of the lens intermediates 51 by using the first and second molding dies 1 and 2 of the embodiment makes the optical axes of the optical functional surfaces unlikely to be shifted from each other and unlikely to tilt, so that the aforementioned manufacturing method makes it possible to form high-precision resin lenses.

In the aforementioned manufacturing method, use of the path 35 formed in the holding member 3 makes it possible to introduce the eight lens intermediates 51 into the positions Q in the corresponding molding chambers 33 in the introducing step while the lens intermediates 51 are coupled to the corresponding first runner parts 501. Use of the path 35 also makes it possible to take the eight molded lenses 54 out of the holding member 3 in the demolding step while the molded lenses 54 are coupled to the corresponding first runner parts 501. Thus, multiple resin lenses are formed in one press molding. Further, the introducing and demolding steps do not require removal of the first or second molding dies 1 or 2 from the holding member 3. This allows shortening of the execution cycle of the press molding, so that the aforementioned manufacturing method is capable of reducing manufacturing costs.

Also, the aforementioned manufacturing method uses the movable bodies 4 to remove the molded lenses 54 from the corresponding first molding dies 1, meaning that the molded lenses 54 are removed easily from the first molding dies 1. Further, the aforementioned manufacturing method makes engagement of the engaging parts 53 with the corresponding engagement receiving parts 42 to guide the eight lens intermediates 51 to the corresponding positions Q. So, the aforementioned manufacturing method allows the lens intermediates 51 to be placed easily at the positions Q, and the lens intermediates 51 are unlikely to be shifted from the corresponding positions Q. Thus, the aforementioned manufacturing method is capable of forming high-precision lenses easily.

Additionally, use of the movable bodies 4 to remove the molded lenses 54 from the corresponding first molding dies 1 further shortens a cycle to form one lens, leading to further reduction of manufacturing costs.

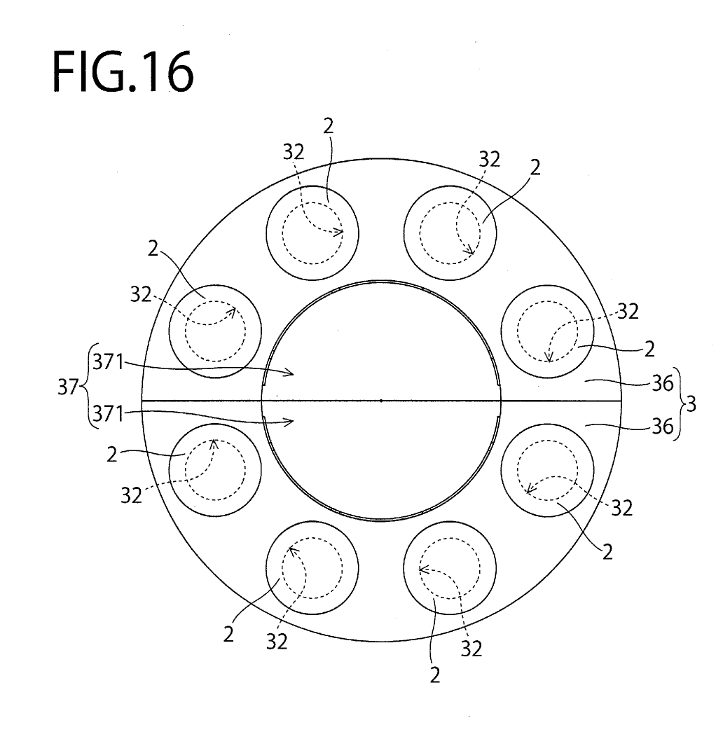

FIG. 16 is a top view of a molding unit used in a modification of the aforementioned manufacturing method. The molding unit shown in FIG. 16 differs from the molding unit described above (FIGS. 2 to 7) in that the holding member 3 is constructed of two joined components 36 capable of being separated from each other. The molding unit used in the modification does not have the second path sections 352. Instead, a hole 37 of the same shapes as those of the first and third path sections 351 and 353 of the molding unit described above (FIGS. 2 to 7) is formed in the holding member 3. The two components 36 are given respective spaces 371 to form the hole 37 when the components 36 are joined to each other. The spaces 371 are exposed at joint surfaces of the components 36. The modification uses the respective spaces 371 of the components 36 as a path that allows introduction of the lens intermediates 51 into the molding chambers 33 belonging to the components 36. More specifically, the spaces 371 function as a path through which the lens intermediates 51 and the runner 50 pass while the lens intermediates 51 are coupled to the corresponding first runner parts 501.

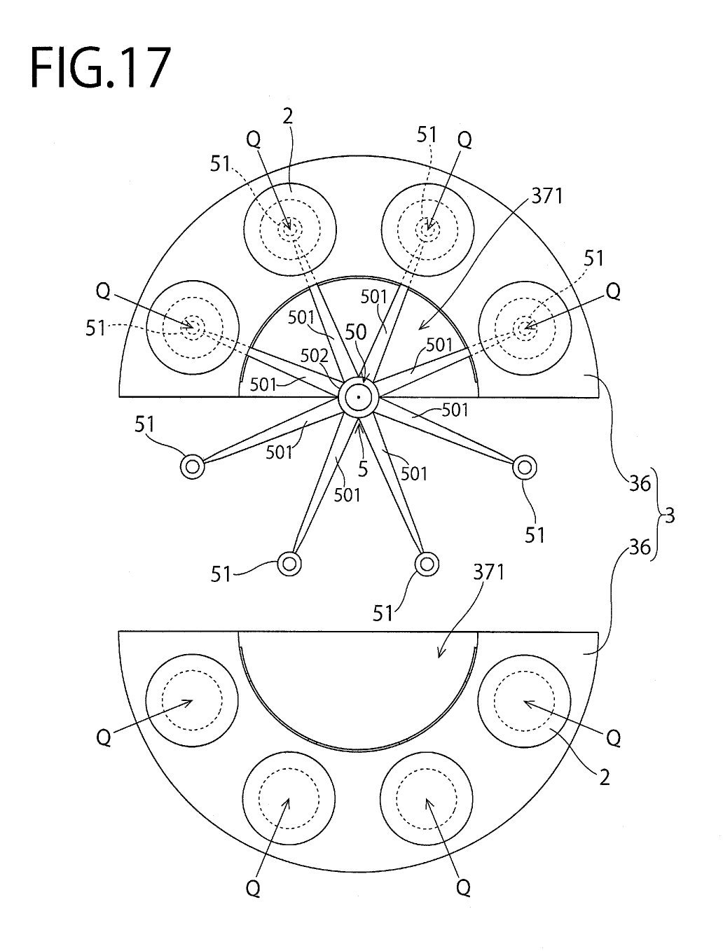

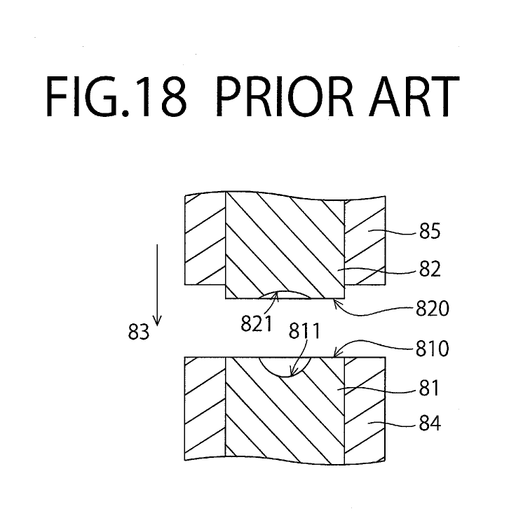

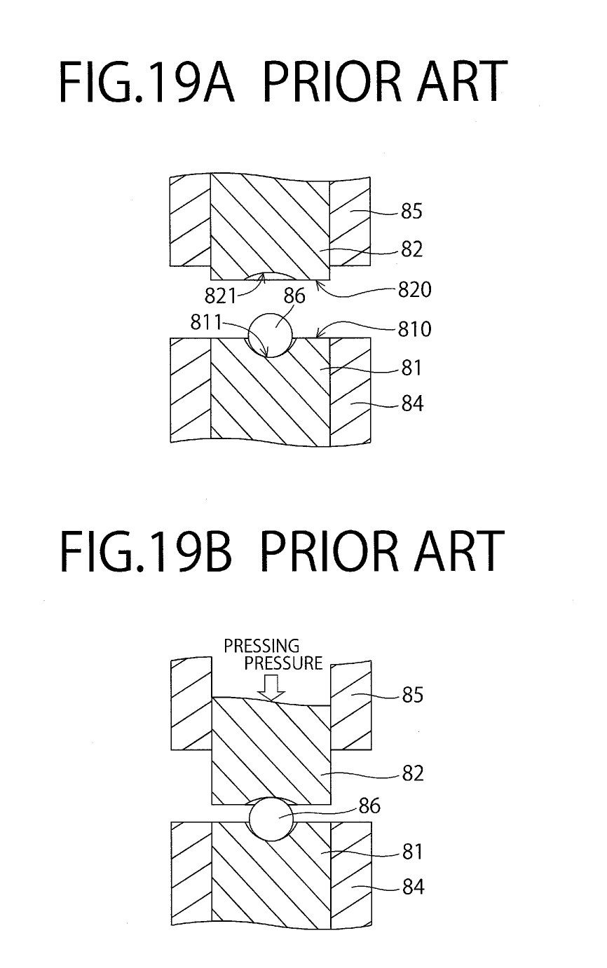

FIG. 17 is a top view used to explain an introducing step that is part of a manufacturing method of the modification. Only the introducing step of the modification differs from the aforementioned introducing step, so the steps of the modification except the introducing step are not described below. As shown in FIG. 17, in the introducing step of the modification, the holding member 3 is first divided into the two components 36. Next, the second runner part 502 of the structure 5 is operated in this state to insert the four lens intermediates 51 and the four first runner parts 501 coupled to these lens intermediates 51 into the space 371 of one of the components 36. Then, the four lens intermediates 51 are guided to the predetermined positions Q in the corresponding molding chambers 33 through this space 371 functioning as a path.

Next, the other one of the components 36 is joined to the aforementioned one of the components 36 to combine the two components 36. At this time, the remaining four lens intermediates 51 and the remaining four first runner parts 501 to which these lens intermediates 51 are coupled are inserted into the space 371 of the other one of the components 36. Then, these four lens intermediates 51 are guided to the positions Q in the corresponding molding chambers 33 through this space 371 functioning as a path. As a result, the eight lens intermediates 51 are placed at the corresponding positions Q.

Like the manufacturing method of the embodiment, the manufacturing method of the modification realizes formation of high-precision resin lenses and reduction of manufacturing costs. The holding member 3 of the molding unit used in the modification may be constructed of three or more components 36 joined to each other.

The structure of each part of the invention is not limited to that shown in the embodiment described above. Various modifications can be devised without departing from the technical scope recited in claims. Regarding the structure 5, for example, not only the shape described in the embodiment but various other shapes are applicable to the structure 5. As an example, the number of multiple lens intermediates 51 coupled to the second runner part 502 is not limited to eight. As another example, the first runner parts 501 may not be spaced from each other at the same angle around the second runner part 502. Further, the shape of the molding unit can be changed in various ways in response to the shape of the structure 5.

In the embodiment described above, regarding the structure 5, the first runner parts 501 extend horizontally from the lower end portion 502a of the second runner part 502 as shown in FIG. 1, and the bottom surfaces of the second path sections 352 (upper surfaces 4a of the movable bodies 4 in the embodiment) extend in a direction substantially perpendicular to the central axis 301 of the holding member 3 as shown in FIG. 10 in response to the shape of the structure 5. However, this is not the only structure of the invention. As an example, the first runner parts 501 may extend obliquely downward or obliquely upward from the lower end portion 502a, so the bottom surfaces of the second path sections 352 may be inclined to get closer to the lower or upper end surface 3a or 3b as they go farther from the central axis 301 in response to this shape of the structure 5. However, extension of the bottom surfaces of the second path sections 352 in a direction substantially perpendicular to the central axis 301 is preferable to extension of the bottom surfaces in different directions as it entails lower manufacturing costs.

The path 35 of the aforementioned molding unit may be of the following shapes. In one example, the second path sections 352 extend from the upper end surface 3b of the holding member 3 only to a depth shallower than the depth position P substantially the same as the position of the molding chambers 33, and the third path section 353 extends obliquely downward from the lower end portions of the second path sections 352 to the molding chambers 33 around the central axis 301 of the holding member 3. In another example, the first and second path sections 351 and 352 extend from the upper end surface 3b to a depth greater than the depth position P, and the third path section 353 extends obliquely upward from the lower end portions of the second path sections 352 to the molding chambers 33 around the central axis 301.

In still another example, all the first and second molding dies 1 and 2 are capable of moving along the axes 302, making the first molding dies 1 and the corresponding second molding dies 2 move to get closer to and farther from each other along the axes 302.

In yet another example, the aforementioned manufacturing method places the lens intermediates 51 at the corresponding positions Q by making a sensor detect or determine the positions of the lens intermediates 51.

1. A method of manufacturing lenses, the method using a molding unit to manufacture lenses out of a structure with a plurality of lens intermediates coupled to each other through a runner, the molding unit including a plurality of first molding dies, a plurality of second molding dies, and a holding member for holding the first and second molding dies,
the holding member being provided with first opening parts, second opening parts, and molding chambers placed at a plurality of places, the first opening parts and the corresponding second opening parts being aligned along predetermined axes and coaxial with each other about the predetermined axes, the molding chambers existing between the first opening parts and the corresponding second opening parts, the first opening parts each receiving the corresponding first molding die inserted into the first opening part and the second opening parts each receiving the corresponding second molding die inserted into the second opening part, the first molding dies and the corresponding second molding dies being capable of moving to get closer to and farther from each other along the corresponding predetermined axes,
the holding member being further provided with a path through which the lens intermediates and the runner pass to allow introduction of the lens intermediates into the corresponding molding chambers from outside the holding member,
the method comprising the steps of:
(a) preparing the structure;
(b) guiding the lens intermediates to predetermined positions in the corresponding molding chambers by operating the structure to cause the lens intermediates and the runner of the structure to move along the path;
(c) heating the lens intermediates;
(d) molding the lens intermediates to form molded lenses by causing the first molding dies and the corresponding second molding dies to move to get closer to each other along the predetermined axes to apply a pressing pressure to the lens intermediates, the step (d) being performed after the step (b) and simultaneously with the step (c);
(e) removing the molded lenses from the first molding dies and the corresponding second molding dies by causing the first molding dies and the corresponding second molding dies to move to get farther from each other along the predetermined axes, the step (e) being performed after the step (d); and
(f) separating the molded lenses from the runner by cutting the structure, the step (f) being performed after the step (e).

2. The method according to claim 1, wherein
the predetermined axes are placed at a plurality of places of the holding member around the central axis of the holding member and substantially parallel to the central axis, the predetermined axes functioning as bases for arrangement of the first opening parts and the corresponding second opening parts,
the path includes:
a first path section extending along the central axis from an end surface of the holding member to a depth position substantially the same as the position of the holding chambers;
second path sections formed between two of the second opening parts adjacent to each other around the central axis, the second path sections extending from the end surface to a depth position substantially the same as the position of the molding chambers, the second path sections communicating with the first path section; and
a third path section extending around the central axis from the second path sections to the molding chambers, the third path section communicating with the first path section,
the runner of the structure prepared in the step (a) includes a plurality of first runner parts and a second runner part with which the structure is operated, the first runner parts extending in a radial pattern from the second runner part, each of the first runner parts being provided with the corresponding lens intermediate at the tip end of the first runner part, and
the step (b) is performed by operating the second runner part of the structure, and which comprises the steps of
(b1) inserting the second runner part into the first path section and inserting the lens intermediates and the first runner parts into the second path section by causing the second runner part to move from above the end surface of the holding member along the central axis of the holding member, and thereafter, causing the second runner part to move further along the central axis to a depth position where the lens intermediates reach the third path section, and
(b2) causing the lens intermediates to move to the predetermined positions in the corresponding molding chambers through the third path section by causing the second runner part to rotate about the central axis, the step (b2) being performed after the step (b1).

3. The method according to claim 1, wherein
the molding chambers are each provided with a corresponding movable body capable of moving along the corresponding predetermined axis, the movable body being capable of moving between first and second positions, the first positions allowing introduction of the lens intermediates into the predetermined positions in the molding chambers, the second positions making the lens intermediates slightly shifted from the predetermined positions along the predetermined axes,
the step (b) guides the lens intermediates into the predetermined positions in the corresponding molding chambers by operating the structure while the movable bodies are placed at the first positions, and
the step (e) removes the molded lenses from the first or second molding dies by causing the movable bodies to move to the second positions to shift the molded lenses from the predetermined positions.

4. The method according to claim 3, wherein
the runner of the structure prepared in the step (a) is provided with an engaging part in the form of a projection and at least one of the movable bodies is provided with an engagement receiving part in the form of a recess to be in engagement with the engaging part, the arrangement of the engagement receiving part being such that the engagement of the engaging part with the engagement receiving part places the lens intermediates substantially at the predetermined positions, and
the step (b) guides the lens intermediates into the predetermined positions in the corresponding molding chambers by operating the structure to make engagement of the engaging part with the corresponding engagement receiving part.

5. A method of manufacturing lenses, the method using a molding unit to manufacture lenses out of a structure with a plurality of lens intermediates coupled to each other through a runner, the molding unit including a plurality of first molding dies, a plurality of second molding dies, and a holding member for holding the first and second molding dies,
the holding member being provided with first opening parts, second opening parts, and molding chambers placed at a plurality of places, the first opening parts and the corresponding second opening parts being aligned along predetermined axes and coaxial with each other about the predetermined axes, the molding chambers existing between the first opening parts and the corresponding second opening parts, the holding member being constructed of a plurality of joined components capable of being separated from each other, a path through which the lens intermediates and the runner pass being exposed at least one of joint surfaces of the components, the path allowing the introduction of the lens intermediates into the corresponding molding chambers,
the first opening parts each receiving the corresponding first molding die inserted into the first opening part and the second opening parts each receiving the corresponding second molding die inserted into the second opening part, the first molding die and the corresponding second molding die being capable of moving to get closer to and farther from each other along the corresponding predetermined axis,
the method comprising the steps of:
(a) preparing the structure;
(b) guiding the lens intermediates to predetermined positions in the corresponding molding chambers through the path, and combining the separated components of the holding member;
(c) heating the lens intermediates;
(d) molding the lens intermediates to form molded lenses by causing the first molding dies and the corresponding second molding dies to move to get closer to each other along the predetermined axes to apply a pressing pressure to the lens intermediates, the step (d) being performed after the step (b) and simultaneously with the step (c);
(e) removing the molded lenses from the first molding dies and the corresponding second molding dies by causing the first molding dies and the corresponding second molding dies to move to get farther from each other along the predetermined axes, the step (e) being performed after the step (d); and
(f) separating the molded lenses from the runner by cutting the structure, the step (f) being performed after the step (e).

6. The method according to claim 5, wherein
the molding chambers are each provided with a corresponding movable body capable of moving along the corresponding predetermined axis, the movable body being capable of moving between first and second positions, the first positions allowing introduction of the lens intermediates into the predetermined positions in the molding chambers, the second positions making the lens intermediates slightly shifted from the predetermined positions along the predetermined axes,
the step (b) guides the lens intermediates into the predetermined positions in the corresponding molding chambers by operating the structure while the movable bodies are placed at the first positions, and
the step (e) removes the molded lenses from the first or second molding dies by causing the movable bodies to move to the second positions to shift the molded lenses from the predetermined positions.

7. The method according to claim 6, wherein
the runner of the structure prepared in the step (a) is provided with an engaging part in the form of a projection and at least one of the movable bodies is provided with an engagement receiving part in the form of a recess to be in engagement with the engaging part, the arrangement of the engagement receiving part being such that the engagement of the engaging part with the engagement receiving part places the lens intermediates substantially at the predetermined positions, and
the step (b) guides the lens intermediates into the predetermined positions in the corresponding molding chambers by operating the structure to make engagement of the engaging part with the corresponding engagement receiving part.
